(19) United States
(12) Patent Application Publication
(10) Pub. No.: US 2007/0020006 A1
(43) Pub. Date: Jan. 25, 2007

(54) Cartridge for image forming apparatus

(75) Inventors: Jun-hee Lee, Suwon-si (KR); Byung-sun Ahn, Suwon-si (KR); Jai-il Choi, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/476,007

(22) Filed: Jun. 28, 2006

(30) Foreign Application Priority Data
Jul. 23, 2005 (KR) 2005-67066

(51) Int. Cl. G03G 21/00

(52) U.S. Cl. 399/350; 399/351

(57) ABSTRACT

An image forming apparatus including a rotating photosensitive drum, a cleaning blade having a cleaning edge part which makes contact with an outer surface of the photosensitive drum along an axial direction of the photosensitive drum and a bracket having a contact surface where the bracket makes contact with the cleaning blade to support the cleaning blade, the width of the contact surface between the bracket and the cleaning blade being maximum at the center part of the cleaning blade and gradually decreasing from the center part to opposite end sides of the cleaning blade. Thus, a cartridge for an image forming apparatus having a cleaning blade and a bracket prevents poor quality in a cleaning surface of a photosensitive drum and has improved durability.

### CROSS-REFERENCE TO RELATED APPLICATIONS

This application claims the benefit of Korean Patent Application No. 2005-67066, filed Jul. 23, 2005, in the Korean Intellectual Property Office, the disclosure of which is incorporated herein by reference.

### BACKGROUND OF THE INVENTION

1. Field of the Invention

Aspects of the present invention relate to a cartridge for an image forming apparatus, and more particularly, to a cartridge for an image forming apparatus having an improved supporting structure of a cleaning blade.

2. Description of the Related Art

A cartridge for an image forming apparatus according to one aspect of the present invention includes a device used when installed in an electrophotographic image forming apparatus, such as a laser beam printer, a multi-function laser printer, a copier, a scanner, a fax machine, etc., and hereinafter is referred to as a cartridge.

FIG. 1 shows the schematic structure of a conventional cartridge 100. The cartridge 100 comprises a photosensitive drum 110 on which a latent image is formed, a developing roller 120 which develops a toner image on the latent image formed on the photosensitive drum 110, and supplying rollers 130 which supply toner to the developing roller 120. The latent image on the photosensitive drum 110 is formed through light scanned by a laser scanning unit 10 which is provided in the image forming apparatus.

The cartridge 100 further comprises a cleaning blade 140 which has an elastic plate for cleaning the surface of the photosensitive drum 110, and a charging roller 160 which charges the surface of the photosensitive drum 110 cleaned by the cleaning blade 14 to a predetermined voltage.

The cleaning blade 140 makes contact with the outer rounded surface of the photosensitive drum 110 with a predetermined pressure and removes toner remaining on the surface of the photosensitive drum 110 while the photosensitive drum 110 is rotating. The cleaning blade 140 is supported by a bracket 150 and fixed to a casing (not shown) of the cartridge 100 by fixing parts 151, which are formed at opposite end parts of the bracket 150.

FIG. 2 shows the forces acting on the cleaning blade 140 and the bracket 150 used in the prior art. In FIG. 2, F_{A} and F_{B} respectively represent a horizontal force and a vertical force loaded on the cleaning blade 140 by the photosensitive drum 110 in FIG. 1. Also, R_{A} and R_{B} represent reaction forces generated on the bracket 150 by the casing of the cartridge 100 and correspond to the magnitudes of F_{A} and F_{B}, respectively.

F_{A} and F_{B}, which are loaded on the cleaning blade 140 by the photosensitive drum 110, are transferred to the bracket 150 through contact surface A and then to the casing of the cartridge 100 through the fixing parts 151 of the bracket 150. As a result, during the course of normal operation, the contact surface A is subject to a tensile stress, a compressive stress and a shear stress.

FIG. 3 is a plan view showing an equilibrium state between the horizontal forces FA and RA loaded on the cleaning blade 140 and the bracket 150 used in the prior art. FA, loaded on the cleaning blade 140 by the photosensitive drum 110, may be represented as a distributed load q[kgf/mm]. In FIG. 3, reference character I represents the length of the photosensitive drum 110 along its axis. A reaction force of the distributed load q corresponds to RA which acts through the fixing parts 151 of the bracket 150 as a pair of divided forces R₁ and R₂ acting at opposite end parts of the bracket 150.

Due to the uneven distribution of the reaction force, the cleaning blade 140 and especially the bracket 150 are elastically deformed to approximately the shape of the dotted line in FIG. 3. As a result of this deformation, the outer surface of the photosensitive drum 110 is not uniformly cleaned, and the central area of the outer surface of the photosensitive drum 110 may not be properly cleaned.

In addition to the problem of not properly cleaning the photosensitive drum, prior art cartridges also encounter the problem that the cleaning blade breaks apart from the bracket. As shown in FIG. 2, the vertical force FB acting on the cleaning blade 140 is supported by the shear stress acting on the contact surface A between the bracket 150 and the cleaning blade 140. However, the cleaning blade 140 often becomes detached from the bracket 150 because of the repetitive acting of FB and the limit of the stress which contact surface A can sustain.

### SUMMARY OF THE INVENTION

Accordingly, it is an aspect of the present invention to provide a cartridge for an image forming apparatus having a cleaning blade and a bracket which prevent poor quality cleaning of the surface of a photosensitive drum. It is another aspect of the present invention to provide a cartridge for an image forming apparatus having a cleaning blade and a bracket with improved durability.

Additional aspects and/or advantages of the present invention will be set forth in part in the description which follows and, in part, will be obvious from the description, or may be learned by practice of the present invention.

The foregoing and/or other aspects of the present invention are also achieved by providing an image forming apparatus comprising a rotating photosensitive drum, a cleaning blade having a cleaning edge part which makes contact with an outer surface of the photosensitive drum along an axial direction of the photosensitive drum, and a bracket having a contact surface where the bracket makes contact with the cleaning blade to support the cleaning blade, wherein the width of the contact surface between the bracket and the cleaning blade is at a maximum at the center part of the cleaning blade and gradually decreases from the center part to opposite end sides of the cleaning blade.

According to another embodiment of the present invention, a lower edge part of the cleaning blade making contact with the bracket extends to a surface of the bracket so that the lower edge part of the cleaning blade is at a maximum at the center part of the cleaning blade and gradually decreases from the center part to opposite end sides of the cleaning blade.

According to another embodiment of the present invention, the lower edge part of the cleaning blade comprises a round part.

According to another embodiment of the present invention, the round part of the cleaning blade is symmetrical.

According to another embodiment of the present invention, the upper edge part of the cleaning blade extends to a surface of the bracket so that the upper edge part of the cleaning blade is at a maximum at the center part of the cleaning blade and gradually decreases from the center part to the opposite end sides of the cleaning blade.

According to another embodiment of the present invention, the upper edge part of the cleaning blade comprises a round part.

According to another embodiment of the present invention, the round part of the cleaning blade is symmetrical.

The foregoing and/or other aspects of the present invention are also achieved by providing an image forming apparatus comprising a rotating photosensitive drum, a cleaning blade having a cleaning edge part which makes contact with an outer surface of the photosensitive drum along an axial direction of the photosensitive drum, a bracket having a contact surface where the bracket makes contact with the cleaning blade to support the cleaning blade, and a free end of the cleaning blade which protrudes from the bracket and contacts with the photosensitive drum, the contact surface being at a maximum at the center part of the cleaning blade and gradually decreasing from the center part to opposite end sides of the cleaning blade.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic side view showing the structure of a conventional cartridge for an image forming apparatus;

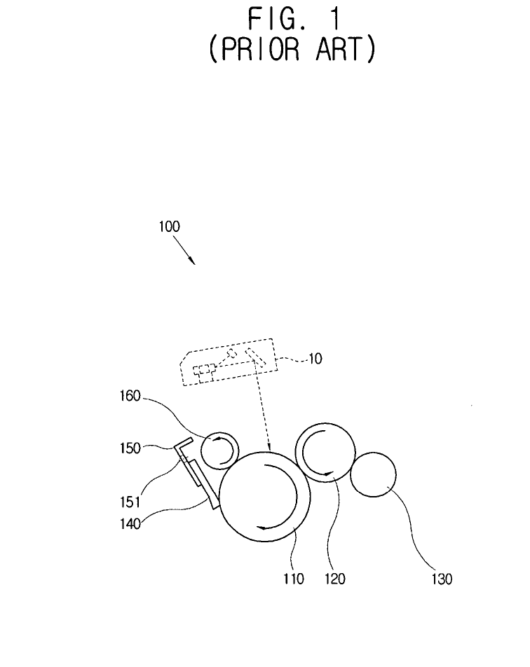

FIG. 2 is a magnified view of the cleaning blade and the bracket in FIG. 1;

FIG. 3 is a plan view showing forces acting on the cleaning blade and the bracket in FIG. 2;

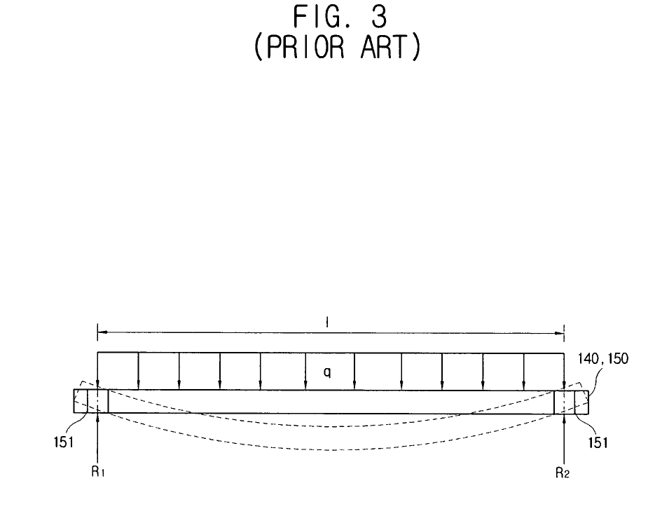

FIG. 4 is a cross sectional view of a cartridge for an image forming apparatus according to an embodiment of the present invention;

FIG. 5 is a schematic view of the cleaning blade and the bracket in FIG. 4, seen at side A;

FIG. 6 is a plan view showing forces acting on the cleaning blade and the bracket in FIG. 4; and

FIG. 7 is a schematic view of the cleaning blade and the bracket in FIG. 4, seen at side B.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

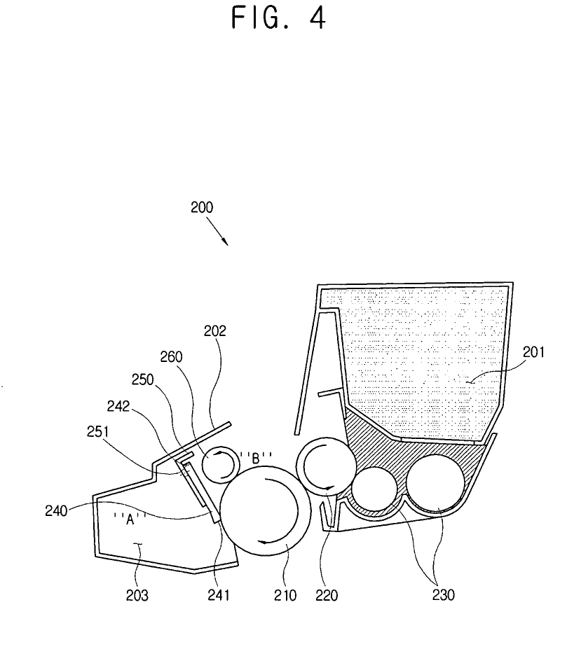

As shown in FIG. 4, a cartridge 200 for an image forming apparatus according to an embodiment of the present invention comprises a photosensitive drum 210, a developing roller 220, a supplying roller 230 and a charging roller 260. The photosensitive drum 210 and the rollers 220, 230 and 260 are similar to those of the conventional cartridge, and detailed descriptions thereof will be omitted. Toner used for developing an image is stored in the storing part 201. The toner is developed to the electrostatic latent image formed on the surface of the photosensitive drum 210 through the supplying roller 230 and the developing roller 220.

The cartridge 200 further comprises a cleaning blade 240 which has an elastic plate for cleaning the surface of the photosensitive drum 210 and a bracket 250 having a contact surface where the bracket 250 makes contact with the cleaning blade 240 to support the cleaning blade 240. The bracket 250 is fixed to a casing 202 through fixing parts 251.

The cleaning blade 240 comprises a cleaning edge 241 at its lower end. The cleaning edge 241 makes contact with the outer round surface of the photosensitive drum 210 so that the cleaning edge 241 can remove the toner remaining on the surface of the photosensitive drum 210 when the photosensitive drum 210 is rotated. The toner removed from the photosensitive drum 210 by the cleaning blade 240 is stored in a waste toner storing part 203.

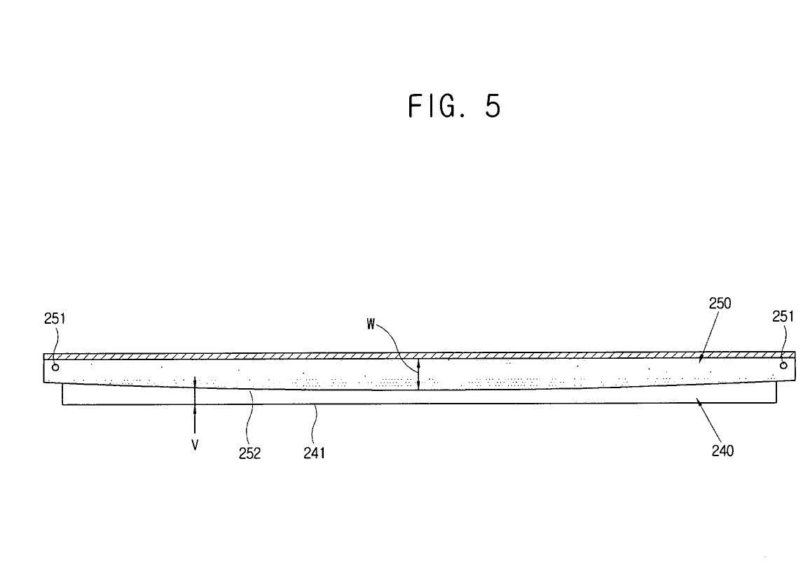

The combination of the cleaning blade 240 and the bracket 250 is shown in FIG. 5.

FIG. 5 shows the cleaning blade 240 and the bracket 250 when seen from “A” in FIG. 4. A lower edge part 252 of the bracket 250 which makes contact with the cleaning blade 240 comprises a downwardly convex round part. Accordingly, the contact surface of the bracket 250 where the bracket 250 makes contact with the cleaning blade 240 is enlarged by the convex round shape of the lower edge part 252, in comparison to the contact surface of a conventional bracket.

Because of the enlarged contact surface between the cleaning blade 240 and the bracket 250, the shear stress acting on the contact surface is decreased and detachment of the cleaning blade 240 from the bracket 250 can be prevented.

The contact surface between the cleaning blade 240 and the bracket 250 has a maximum width W at the center part of the cleaning blade 240 due to the rounded lower edge part 252 of the bracket 250. The width W gradually decreases from the center part to the opposite sides and is at a minimum at the opposite end sides of the cleaning blade 240.

Considering that the elastic deformation of the cleaning blade 240 is at a maximum at its center due to the distributed load by the photosensitive drum 210, the shape of the rounded lower edge part 252 is preferably symmetrical. However, the shape of the rounded lower edge part 252 does not have to be symmetrical. There are many different shapes that could be used in accordance with the present invention to prevent the elastic deformation of the cleaning blade 240.

Due to the shape of the lower edge part 252 of the bracket 250, the width V between the lower edge part 252 and the lower edge of the cleaning edge 241 of the cleaning blade 240 is at a minimum at the center part of the cleaning blade 240 and at a maximum at the opposite end parts of the cleaning blade 240.

To compensate for the difference in the stress applied at the opposite end parts of the blade 240, the lower edge part 252 of the bracket 250 may have not only a round shape but also a stepped shape from the center part to the opposite end parts. In this case, the width V between the cleaning edge 241 of the blade 240 and the lower edge part 252 of the bracket 250 is larger when getting closer to the opposite end parts of the blade 240 because of the stepped shape of the lower edge part 252.

Or, the width V may be formed according to the change of the curvature of the lower edge part 252 of the bracket 250, where the curvature is smaller when getting closer to the opposite end parts of the lower edge part 252 compared to the center part of the lower edge part 252. This embodiment would also reduce the shear stress acting on the contact surface between the cleaning blade 240 and the bracket 250.

The bracket 250 comprises the fixing parts 251 at opposite end parts to couple the bracket 250 with the casing 202.

According to the above coupling between the cleaning blade 240 and the bracket 250, the amount of the elastic deformation at the center part of the cleaning edge 241 may be controlled to be the same amount of elastic deformation as the amount of elastic deformation at the opposite end parts of the cleaning edges 241 when the horizontal force FA is loaded on the cleaning blade 240. Thus, as a result of this uniform elastic deformation, the toner remaining on the photosensitive drum 210 may be uniformly removed regardless of its positioning at the center part or at the end parts.

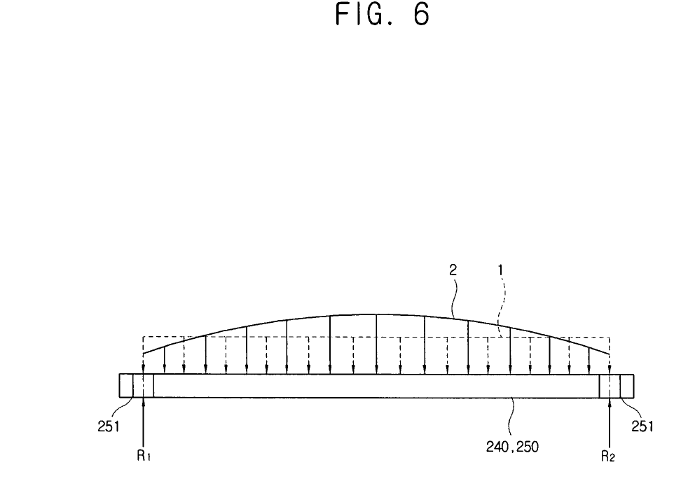

Because of the shape of the lower edge part 252 of the bracket 250, the distributed load which acts on the cleaning edge 241 by the rotating photosensitive drum 210 is shown as a curved line 2 in FIG. 6. According to the curved line 2, the maximum load is at the center part of the cleaning edge 241, and the minimum loads are at the opposite end parts of the cleaning edge 241. It can be inferred that the shape of the above load distribution is similar to the shape of the lower edge part 252.

A dotted straight line 1 in FIG. 6 represents the shape of the cleaning blade and bracket after the uniformly distributed load q acts on the cleaning blade (240 in FIG. 4) and the bracket (250 in FIG. 4) of the present invention. This uniform distribution of q results in a substantial decrease in the elastic deformation of the cleaning blade 240 and bracket 250 of the present invention.

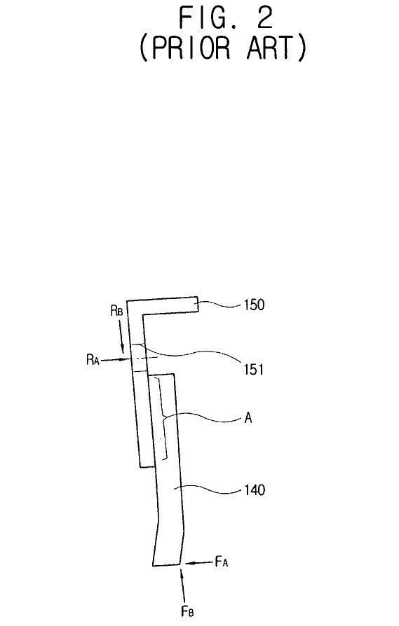

The vertical force (similar to FB in FIG. 2) acting on the cleaning blade 240 is supported by the contact surface between the bracket 250 and the cleaning blade 240 which is enlarged by the lower edge part 252 of the bracket 250, so that the shear stress acting on the contact surface is decreased to prevent the detachment between the cleaning blade 240 and the bracket 250.

The drawings in the description of the present invention are simplified through modeling for the illustration of the present invention However, the divided forces R1 and R2 may be distributed in a larger area. Therefore, the exact width V of the blade 240 may be optimized through experiments and calculations according to specific products.

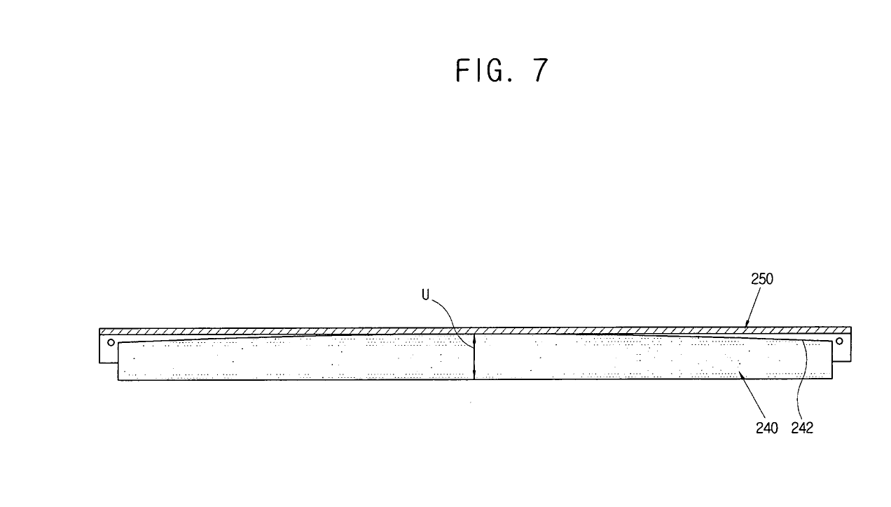

To enlarge the contact surface between the cleaning blade 240 and the bracket 250, an upper edge part 242 of the cleaning blade 240 may be extended to have a round part, which is shown in FIG. 7. FIG. 7 shows the cleaning blade 240 and the bracket 250 combined with each other when seen from “B” in FIG. 4.

In this case, the contact surface between the cleaning blade 240 and the bracket 250 has a width U which is at a maximum at the center part of the cleaning blade 240 due to the round upper edge part 242 of the cleaning blade 240. The width U decreases from the center part to the opposite sides, and is at a minimum at the opposite end parts of the cleaning blade 240.

The upper edge part 242 of the cleaning blade 240 in FIG. 7 may be used in combination with the lower edge part 252 of the bracket 250 in FIG. 5 to further increase the effectiveness of the present invention.

In the above embodiment, the lower edge part 252 of the bracket 250 and the upper edge part 242 of the cleaning blade 240 are not limited to having round edges. They may also have stepped shapes.

Although a few embodiments of the present invention have been shown and described, it would be appreciated by those skilled in the art that changes may be made in these embodiments without departing from the principles and spirit of the invention, the scope of which is defined in the appended claims and their equivalents.

What is claimed is:

1. An image forming apparatus comprising:
a rotating photosensitive drum;
a cleaning blade having a cleaning edge part which makes contact with an outer surface of the photosensitive drum along an axial direction of the photosensitive drum; and
a bracket arranged to support the cleaning blade and having a contact surface with the cleaning blade, a width of the contact surface between the bracket and the cleaning blade being at a maximum at a center part of the cleaning blade and decreasing from the center part of the cleaning blade to opposite end sides of the cleaning blade.

2. The image forming apparatus according to claim 1, wherein an edge part of the bracket making contact with the cleaning blade is at a maximum at the center part of the cleaning blade and decreases from the center part to the opposite end sides of the bracket.

3. The image forming apparatus according to claim 2, wherein the edge part of the bracket comprises a round part.

4. The image forming apparatus according to claim 3, wherein the round part of the bracket about the center part of the cleaning blade is symmetrical.

5. The image forming apparatus according to claim 1, wherein an edge part of the cleaning blade making contact with the bracket is at a maximum at the center part of the cleaning blade and decreases from the center part of the cleaning blade to the opposite end sides of the cleaning blade.

6. The image forming apparatus according to claim 5, wherein the edge part of the cleaning blade comprises a round part.

7. The image forming apparatus according to claim 6, wherein the round part of the cleaning blade about the center part of the cleaning blade is symmetrical.

8. The image forming apparatus according to claim 2, wherein an edge part of the cleaning blade making contact with the bracket is at a maximum at the center part of the cleaning blade and gradually decreases from the center part of the cleaning blade to the opposite end sides of the cleaning blade.

9. The image forming apparatus according to claim 8, wherein the edge part of the cleaning blade comprises a round part.

10. The image forming apparatus according to claim 9, wherein the round part of the cleaning blade about the center part of the cleaning blade is symmetrical.

11. The image forming apparatus according to claim 3, wherein an edge part of the cleaning blade making contact with the bracket is at a maximum at the center part of the cleaning blade and decreases from the center part of the cleaning blade to the opposite end sides of the cleaning blade.

12. The image forming apparatus according to claim 11, wherein the edge part of the cleaning blade comprises a round part.

13. The image forming apparatus according to claim 12, wherein the round part of the cleaning blade about the center part of the cleaning blade is symmetrical.

14. The image forming apparatus according to claim 4, wherein an edge part of the cleaning blade making contact with the bracket is at a maximum at the center part of the cleaning blade and decreases from the center part of the cleaning blade to the opposite end sides of the cleaning blade.

15. The image forming apparatus according to claim 14, wherein the edge part of the cleaning blade comprises a round part.

16. The image forming apparatus according to claim 15, wherein the round part of the cleaning blade about the center part of the cleaning blade is symmetrical.

17. An image forming apparatus comprising:
a rotating photosensitive drum;
a cleaning blade which makes contact with an outer surface of the rotating photosensitive drum along an axial direction of the rotating photosensitive drum; and
a bracket arranged to support the cleaning blade, wherein a geometrical configuration of the cleaning blade and bracket uniformly distribute elastic deformation on the cleaning blade caused by the rotation of the photosensitive drum.

18. The image forming apparatus of claim 17, wherein a width of a contact surface area between the bracket and the cleaning blade is at a maximum at a center part of the cleaning blade and decreases from a center part of the cleaning blade to opposite end sides of the cleaning blade.

19. The image forming apparatus of claim 18, wherein an edge part of the cleaning blade making contact with the bracket is at a maximum at the center part of the cleaning blade and decreases from the center part of the cleaning blade to the opposite end sides of the cleaning blade.

20. The image forming apparatus of claim 18, wherein an edge part of the bracket making contact with the cleaning blade is at a maximum at a center part of the bracket and decreases from the center part of the bracket to opposite end sides of the bracket.

21. The image forming apparatus of claim 19, wherein an edge part of the bracket making contact with the cleaning blade is at a maximum at the center part of the bracket and decreases from the center part of the bracket to opposite end sides of the bracket.

22. An image forming apparatus, comprising:
a rotating photosensitive drum,
a cleaning blade which makes contact with an outer surface of the rotating photosensitive drum along an axial direction of the photosensitive drum,
a bracket which supports the cleaning blade; and
fixing parts on opposite sides of the bracket, wherein a width of a contact surface area between the bracket and the cleaning blade is at a maximum at a center part of the cleaning blade and decreases from the center part of the cleaning blade to opposite end sides of the cleaning blade, in order to offset elastic deformation of the cleaning blade caused by a reaction force of the fixing parts against a force of the rotating photosensitive drum.

23. The image forming apparatus of claim 22, wherein an edge part of the cleaning blade making contact with the bracket is at a maximum at the center part of the cleaning blade and decreases from the center part of the cleaning blade to the opposite end sides of the cleaning blade.

24. The image forming apparatus of claim 22, wherein an edge part of the bracket making contact with the cleaning blade is at a maximum at a center part of the bracket and decreases from the center part of the bracket to opposite end sides of the bracket.

25. The image forming apparatus of claim 23, wherein an edge part of the bracket making contact with the cleaning blade is at a maximum at a center part of the bracket and decreases from the center part of the bracket to opposite end sides of the bracket.
